(19) United States
(12) Patent Application Publication
(10) Pub. No.: US 2009/0089234 A1
(43) Pub. Date: Apr. 2, 2009

(54) AUTOMATED CODE GENERATION FOR SIMULATORS

(75) Inventors: David Thayer Sturrock, Evans City, PA (US); Glenn Richardson Drake, Panama City (PA); Cory R. Crooks, Moon Township, PA (US); A. David Takus, Sewickley, PA (US); Mark Anson Glavach, Slippery Rock, PA (US); Genevieve O'Neill Kolt, Painesville, OH (US); Frank Anthony Palmieri, JR., Gibsonia, PA (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 11/864,451

(22) Filed: Sep. 28, 2007

(51) Int. Cl. G06F 15/18; G06F 9/455

(52) U.S. Cl. 706/45; 703/22

(57) ABSTRACT

A system that generates deployable runtime code modules is provided. The system includes an input component that accepts specifications in accordance with design preferences, a simulation component that creates and executes a simulation of the control program to be implemented, and a code generation component that creates the deployable runtime code.

### TECHNICAL FIELD

The claimed subject matter relates generally to industrial control systems and more particularly to automatically generating deployable runtime code from simulation models.

### BACKGROUND

Simulation and modeling for automation has advanced considerably in recent years. In one instance, manufacturers employ simulation for business purposes. While some have utilized simulation to close sales with suppliers, other manufacturers employ simulation for supply chain planning. For example, if it is known how many items are produced for a given line, then it can be determined where production needs to occur and what equipment needs to drive the production while yielding confidence in the final production outcome. Entities can also predict delivery schedules from simulations. Design engineers are using simulation to alter their designs to make products easier to manufacture, whereas many companies are now creating simulations of entire plants before a plant is built or refurbished.

One recent trend is the use of simulation to train plant personnel. There are two main areas where simulation has helped in training. In one, simulation allows less skilled workers to practice and gain experience “operating” plant equipment before taking the reins in the real world. In another, simulated operation offers an accelerated form of training. For instance, input/output (I/O) simulation software provides a shortcut to training on actual equipment that may not even be available at the present time, where training materials can be created from simulated manufacturing design. Training is often considered a secondary use of simulation, but the savings it produces can be considerable nonetheless. Another recent development in simulation mirrors progress in other areas of computer technology: standardization of data. One of the trends in simulation is the ability to share data. Thus, users share data in many directions, from product design and manufacturing to robot simulation and ergonomics, for example.

Three-dimensional modeling has gained ground in manufacturing simulation. Three-dimensional modeling first was applied in the aerospace and automotive sectors. Often, designers model robots in 3-D, then select the location for the respective operation such as “weld” and instruct the robot to perform along those lines. As for parameters such as pressure and the robot's maneuverability, such parameters can be built into the simulation and delivered by the robot manufacturer, thus preventing a simulation from inadvertently instructing the robot to perform an operation that is beyond its capabilities. Often times the robots are controlled from one or more programmable controllers that can also be simulated.

When a company has its manufacturing process fully simulated, it becomes easier to analyze a product design and observe how well it performs in a manufacturing setting. Since the design and manufacturing are not yet “live,” there is an opportunity to turn back to the design engineer and request changes before it is cost prohibitive to do so. Such changes at the simulation stage are generally much less costly to implement than at the actual manufacturing stage. Thus, early on in the life of the product, designers can analyze the simulated manufacturing process, and adjust a given product for desired manufacturability. The ability to alter a product design prior to manufacturing in order to cause the entire process to work more efficiently offers significant potential savings over the traditional design process. This process is often referred to as front-loading, where a designer can identify manufacturing glitches through simulation and then facilitate planning on how to overcome such problems. With front-loading, products can be designed so it performs well in the manufacturing simulation which should mitigate problems in actual production thus mitigating overall system costs.

Simulation can also be implemented end-to-end, thus demonstrating how every process in a plant performs together over a designated period of time. For instance, simulation can occur from the controller level up to warehouse management and other supervisory systems. One area where simulations of the entire plant are taking hold is with new plants or newly refitted plants. Before manufacturers determine what equipment they need and where it should go, they simulate the plant's entire operations. Dynamic simulation thus provides a model for a new plant to ensure the plant is designed properly.

Prior to implementing an industrial control program, simulations are often performed in an offline manner to determine projected performance for a particular control system. The simulation process often includes manually designing code or other modules that perform a given simulation and drive the actual production equipment. However, it is not economically practical to continually develop models or other types of simulation code from scratch. Programmers face an enormous amount of tedious work when they must repeatedly develop run-time code from scratch after simulations have been developed and executed.

### SUMMARY OF THE INVENTION

The following summary presents a simplified overview of the invention to provide a basic understanding of certain aspects of the invention. This summary is not an extensive overview of the invention. Nor is the summary intended to identify critical elements of the invention or delineate the scope of the invention. The sole purpose of this summary is to present some features offered by the invention in a simplified form as a prelude to a more detailed description presented later.

Industrial automation simulation tools are provided that automatically generate code modules or models that are employed in the context of an industrial control simulation environment. Re-usable simulation instructions or add-on instructions can be provided to facilitate construction of an overall simulation model. After the respective model has been executed to desired satisfaction, actual industrial controller (IC) code or other type instructions can be automatically generated and loaded on run time equipment. This can include providing instruction templates for integrating into a given environment such as providing suggested code or integration instructions for interfacing one type of equipment with another e.g., integrating a drives package with an industrial controller and generating the instructions for the drive and respective controller. Actual code objects can be automatically generated to run a simulation on actual equipment, automatically generated after a simulation and downloaded to the equipment, or generated in a report format in order to verify a given system such as for highly regulated industries.

To the accomplishment of the foregoing and related ends, the following description and annexed drawings set forth in detail certain illustrative aspects of the invention. These aspects are indicative of but a few of the various ways in which the principles of the invention may be employed. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating an automated code generator for an industrial automation control system.

FIG. 2 is an illustration of a user interface that accepts a variety of input parameters from a user.

FIG. 3 is a diagram illustrating aspects of obtaining specifications from a user.

FIG. 4 is a diagram illustrating a simulation component that has been functionally decomposed into utility components.

FIG. 5 is a diagram illustrating a code generation component that has been functionally decomposed into utility components.

FIG. 6 is a diagram illustrating a translation component.

FIG. 7 is a diagram illustrating one aspect of implementing a deployable runtime code module.

FIG. 8 is a diagram illustrating a feedback loop that monitors implementations of deployable runtime code modules.

FIG. 9 is a flow diagram illustrating a code generation methodology.

FIG. 10 is a flow diagram illustrating an additional aspect of a code generation methodology.

FIG. 11 is a flow diagram illustrating a code generation methodology that utilizes feedback to monitor implementations of deployable runtime code modules.

### DETAILED DESCRIPTION OF THE INVENTION

A reduced subset of simulation and code generation components is provided to mitigate manual coding requirements that often accompany the process of simulating and implementing new control devices (such as industrial controllers) in an industrial control environment. In one aspect, a system that generates deployable runtime code modules is provided. The system includes an input component that accepts specifications in accordance with a user's desires, a simulation component that creates and executes a simulation of the control program to be implemented, and a code generation component that creates the deployable runtime code.

It is noted that as used in this application, terms such as “component,” “module,” “model,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process or thread of execution and a component may be localized on one computer or distributed between two or more computers, industrial controllers, or modules communicating therewith.

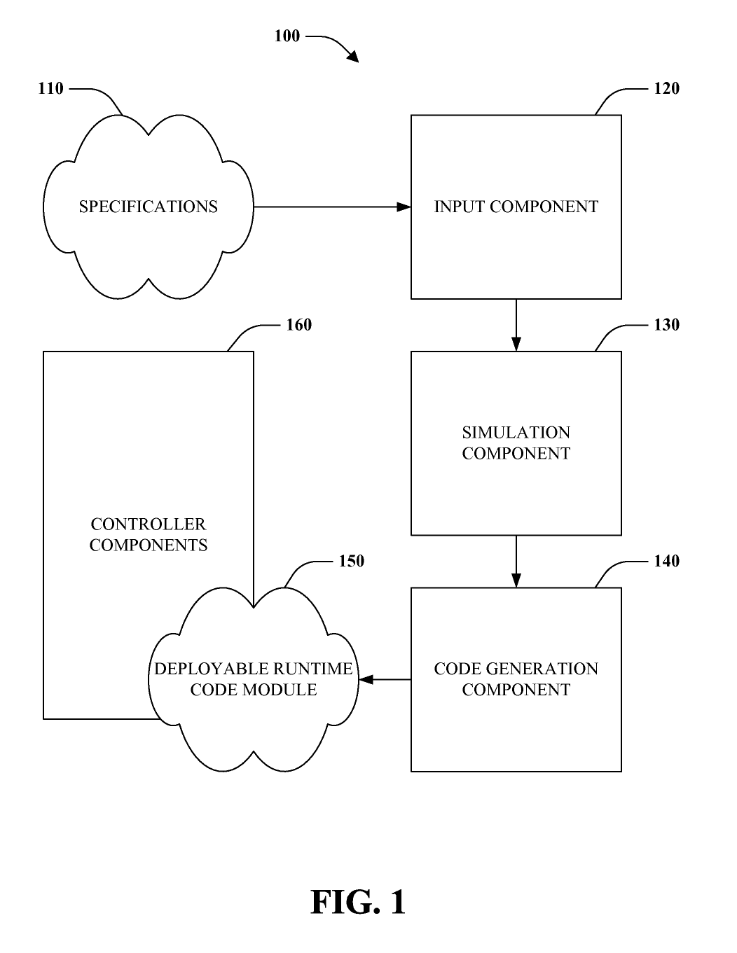

Referring initially to FIG. 1, a system 100 illustrates automated code generation components for providing deployable runtime code modules from simulations and higher-level specifications in an industrial control environment. Generally, a user can provide the system with a plurality of specifications 110 in accordance with the user's design preferences or desires such as performance and operating conditions of a factory or machine. For example, the user may specify preferences including a particular functionality (e.g., the product will have features X, Y, and Z) or goal (e.g., production yield should be 10 k units per day, percentage of good units to be 90%, and so forth). The specifications 110 can also be automatically accumulated or generated such as automatically retrieving the specifications or components thereof from a database or network, such as the Internet for example. An input component 120 accepts and stores the specifications 110 from the user for later use. In one aspect, the user enters the specifications 110 into a computer terminal with a plurality of blank fields that pertains to different aspects regarding the user specification. In another aspect, the user links the input component 120 to a database that houses the specifications and the specifications are accessed or downloaded as the need arises. In yet another aspect, the input component 120 automatically generates the specification by analyzing historical data trends or by anticipating user specifications.

A simulation component 130 constructs and executes simulation models in accordance with the specifications 110 set forth by the input component 120 as well as a cross-section of real time variables (e.g., a range of operating temperatures, variations in materials such as thickness, properties, and so forth) that inherently occur in an industrial control setting. The simulation component 130 also identifies suitable process control equipment (e.g., a batch server, an industrial controller, individual devices, I/O, and so forth), process control steps, or methodologies to accomplish the manufacture of a particular item.

When the simulation component 130 identifies the components or methodologies, it defines simulation models for the respective components or steps. Simulation models may be stored in a simulation database (not shown) that includes a history of simulations that have been previously run. It is to be noted that such simulation database may be accessed through remote connections such as the Internet. Other simulation models may be formed based on logic, historical simulation models, the user specification, or artificial intelligence. Alternatively, the simulation component 130 may prompt the user for a simulation model that is not found within the database, difficult to generate, or specific to the user.

When the simulation models have been identified and gathered, the simulation component 130 executes a simulation based on the simulation models, stores and returns the result of the simulation. By storing the results of the simulations, users can quickly identify failed or successful simulations, as well as simulation models that are similar to the current simulation for comparative purposes. If a problem occurs during simulation or the simulation fails, the simulation component 130 identifies the particular simulation models that were the root of the failure. In one aspect, the simulation component 130 simulates to the smallest level of granularity to facilitate the most accurate simulation possible. However, if a particular combination of simulation models has been run repeatedly, the simulation component 130 can identify this through the simulation database, notify the user that a repeated simulation has been executed, and refrain simulating that portion of the model (perhaps after prompting the user for permission).

A code generation component 140 creates deployable runtime code modules 150 that are employed to drive various controller components 160 throughout the industrial automation environment. The code generation component 140 receives results from simulation component 130 to automatically create the runtime code modules 150. In one aspect, the runtime code modules 150 may be obtained by translating the simulation models into the appropriate controller or device specific language modules. This may include ladder logic that drives industrial controllers, Sequential Function Charts, operational parameters or settings, programming language (e.g., C++, Java, assembly, and so forth) code to control various types of processors or other equipment. The code generation component 140 may generate several options for the user to select that may not fall within the user specifications but otherwise emphasize optimum or potential performance capabilities for the industrial automation system.

For example, the code generation component 140 can operate with a translation component (not shown) that will be described in more detail below. The translation component can map a code module that performs a desired function with a component of the simulation that corresponds to a portion of the specification 110. If a particular simulation component were a industrial controller processor that controlled a mixing operation for example, the translation component can map controller code or other parameters associated with a mixing process from the resultant simulation of such mixing. Code modules 150 can be collected and stored over time (according to various processes or functions) or automatically generated as will be described in more detail below.

It is to be appreciated that the code generation component 140 may be linked to the controller components 160 via various networks. The industrial control system 100 may employ such a connection by automatically implementing generated runtime code modules 150 in substantially any controller component 160 that is associated with the code generation component 140. For example, the simulations and code generation may occur on a computer located in the factory control room, where the computer is connected to the mainframe that oversees production in the factory. After a successful simulation has been run, and the runtime code generated, the user can program the mainframe with the updated runtime code and re-program selected industrial controllers to operate under the new specifications. Alternatively, an operator may load the deployable runtime code modules manually if the controller components 160 are not remotely accessible.

Additionally, the code generation component 140 can track and log actual industrial controller activity or responses and compare the actual data from the deployable runtime code modules that have been implemented to the simulation models. This provides a feedback loop with a record of simulation accuracy from past simulations and offers the user a continually updated database for improving correlation between simulation model results and real life occurrences. Statistical tools may then be used to estimate the accuracy of a particular simulation upon initial implementation of the runtime code modules. In another aspect, the system 100 is employed to automatically generate executable control code. This can include means for defining one or more specifications of a control system (input component 120) and means for simulating the specifications (simulation component 130). This can also include means for generating run time code (code generation component 140) from simulation of the specifications.

It is noted that components associated with the system 100 can include various computer or network components such as servers, clients, industrial controllers (ICs), communications modules, mobile computers, wireless components, control components and so forth that are capable of interacting across a network. Similarly, the term IC as used herein can include functionality that can be shared across multiple components, systems, or networks. For example, one or more controllers can communicate and cooperate with various network devices across the network. This can include substantially any type of control, communications module, computer, I/O device, sensors, Human Machine Interface (HMI) that communicate via the network that includes control, automation, or public networks. The controller can also communicate to and control various other devices such as Input/Output modules including Analog, Digital, Programmed/Intelligent I/O modules, other programmable controllers, communications modules, sensors, output devices, and the like.

The network can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware or software components). These include components such as switches with virtual local area network (VLAN) capability, LANs, WANs, proxies, gateways, routers, firewalls, virtual private network (VPN) devices, servers, clients, computers, configuration tools, monitoring tools, or other devices.

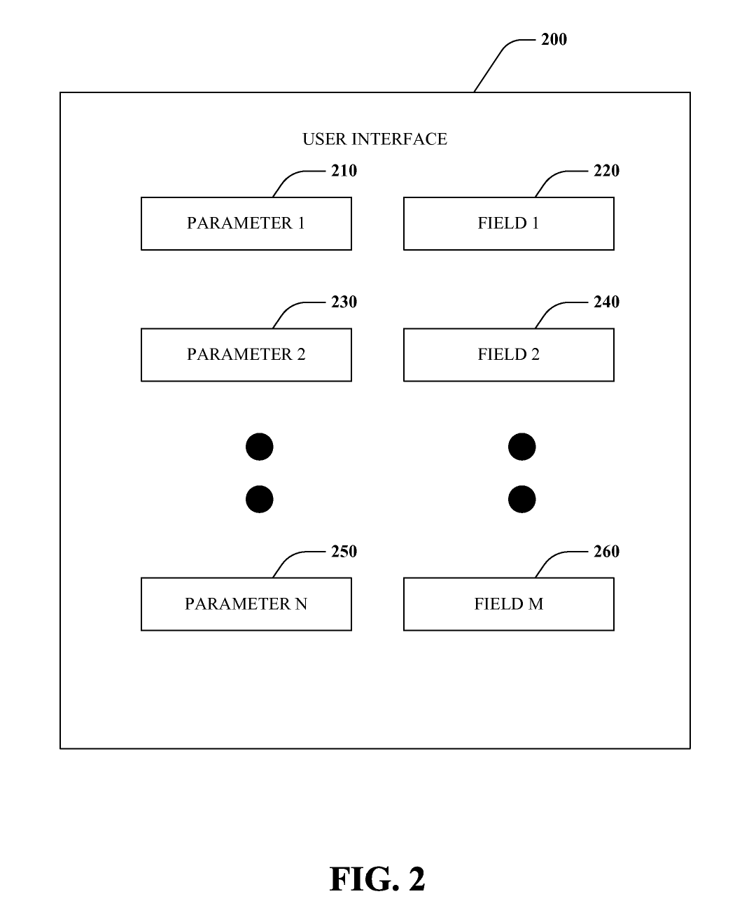

Referring now to FIG. 2, a user interface 200 is provided so the user can communicate a given specification to the input components described above. The specification can consist of a multitude of parameters that correspond to user desires or goals. For example, the user could provide a plurality of goals or operating conditions in the specification that include operating temperature, a desired quantity of product to be produced per time frame, and a desired yield percentage. A parameter box 210 is provided to permit the user to label individual parameters from different portions of the specification, for example. A field box 220 is provided in the user interface 200 to enable the user to input a particular goal that corresponds to the label in parameter box 210.

Alternatively, the user interface 200 could automatically fill the parameter box labels for the user if existing parameters are commonly used. The user interface 200 could communicate with a database component (not shown) to determine possible parameters, parameter ranges, and parameter limits. Upon retrieval of the parameter data, the user interface 200 can present this information to the user in the form of a parameter box label 210 and a parameter field drop down selection box 220.

For instance, an industrial controller that controls a motor may be expected to have different operating speed settings or revolutions per minute (RPM) settings. First, the user interface 200 would communicate with the database component and determine the variables that could be included as parameters such as input voltage, operating speed (RPMs), and torque. User interface 200 may determine that the motor could accept three input voltage levels: low, nominal, and high, for example. The user interface 200 may further determine that the motor outputs run at either a low or high level of torque and that it can run between five hundred and one thousand RPMs. Upon determination of the parameter data, user interface 200 automatically labels parameter box 210 with an “Input Voltage” label and creates a drop down box in field box 220 that lists the three possible settings for the user to choose. Similarly, user interface 200 could label parameter box 230 as “Torque” and create a drop down box with the two possible settings from which the user could choose. Again, user interface 200 would automatically label parameter box 250 as “RPM setting”. In this situation, however, field box 260 could be left blank and the user interface 200 could prompt the user to input an RPM number between five hundred and one thousand.

It is to be noted that the claimed subject matter is not limited to parameters that are stored within a database. The user may input parameters that do not directly correspond to a particular component. For instance, a user could provide a parameter that recites output of one hundred units per day. The user interface 200 may facilitate the implementation of such a parameter through the determination of suitable process control equipment or processes (to be described in more detail below).

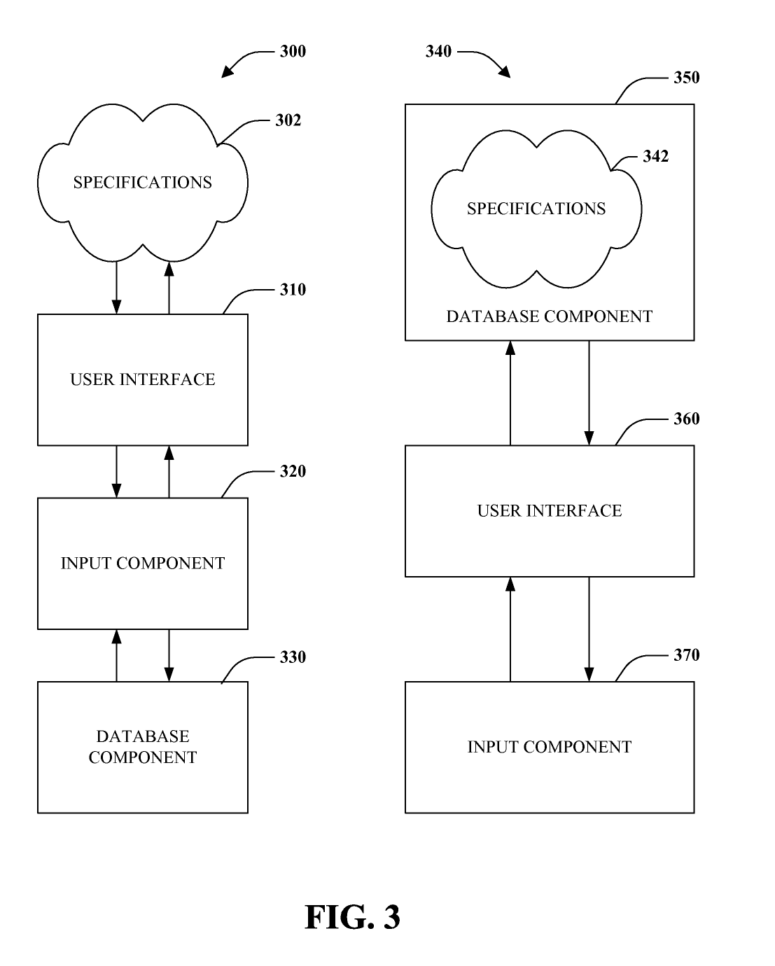

Turning to FIG. 3, a system 300 illustrates gathering specifications 302 from the user through the user interface 310, communicating the specifications to input component 320, and storing the specifications in database component 330. Alternatively, a system 340 illustrates specifications 342 that have been entered in the past may be stored in a database component 350, presented to the user via a user interface 360, and entered into an input component 360 after selection by the user.

The input component 320, 370 accepts and stores the specifications 302, 342 from the user for later use. In one aspect, the user enters the specifications 302, 342 into a computer terminal (that represents the user interface 310, 360) with a plurality of fields that pertains to different parameters regarding the user specification.

In another aspect, the user links the input component 370 to a database 340 that houses the specifications 342 and the specifications are accessed or downloaded as the need arises. In yet another aspect, the input component 320, 370 automatically generates the specification by analyzing historical data trends or by anticipating user specifications. It is to be appreciated that data utilized to facilitate automatic generation of specification 302, 342 can be housed within database component 340 or accessed through a network such as the Internet.

The input component 320 or 370 can determine if additional specifications would be needed to facilitate simulation and automatic code generation. If the user provides a high-level set of instructions as the specification, the input component 320, 370 can decompose the high-level specification into sub-parameters as the need arises. Decomposition can occur through a variety of techniques and the following examples are not intended to limit the scope of the invention. A logic component (not shown) can be used to determine suitable sub-parameters based on process control equipment to be used or processes to be implemented (described in more detail below). Database 340 stores the results of parameter decomposition to access for later use. For example, if a controller drives a motor, and the user submits a specification that includes a parameter calling for the motor to run at one thousand RPMs and the motor must have an input voltage of 12V to do so, the input component 320, 370 can utilize logic to associate the user specification with the known properties of the motor and return the additional parameter of 12V to the user interface 310. Similarly, if the user submits a specification 302, 342 of one hundred units of production per day, the input component 320, 370 may recognize that two processes are required to complete manufacture of a unit and that each process takes twenty-four hours to complete and thus, notify the user that the specification is not feasible through the current setup due to the time limitation. If it would be possible to meet a specification through the purchase of additional manufacturing equipment, or removal of a certain limitation, the input component 320 or 370 can notify the user of such possibility.

In accordance with another aspect, the input component 320, 370 can utilize artificial intelligence component (not shown) to automatically infer parameters to suggest to the user. The artificial intelligence (AI) component can include an inference component (not shown) that can further enhance automated aspects of the AI components utilizing, in part, inference based schemes to facilitate inferring intended parameters. The AI-based aspects can be effectuated via any suitable machine learning based technique or statistical based techniques, or probabilistic-based techniques or fuzzy logic techniques. Specifically, the AI is provided to execute simulation aspects based upon AI processes (e.g., confidence, inference). For example, a process for defining a parameter can be facilitated via an automatic classifier system and process. Furthermore, the AI component can be employed to facilitate an automated process of creating a parameter in accordance with historical user trends.

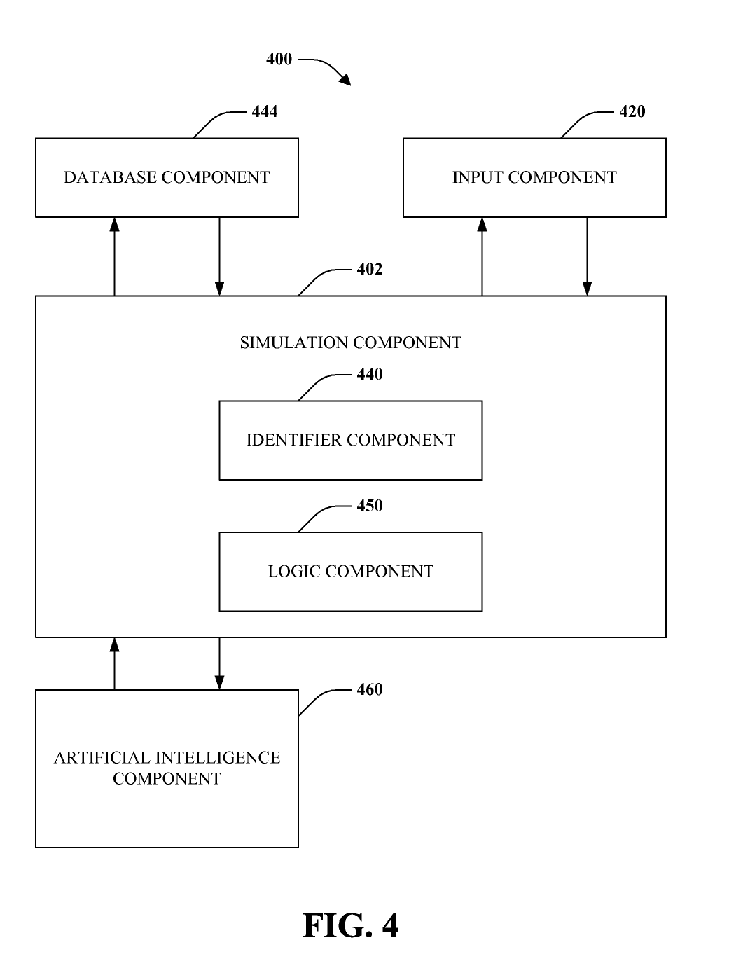

Referring to FIG. 4, a detailed system 400 employing a simulation component 402 is illustrated. The simulation component 402 receives a set of parameters from an input component 420. As noted supra, the parameters may be derived or decomposed from a specification provided by the user and certain parameters can be inferred, suggested, or determined based on logic or artificial intelligence. An identifier component 440 identifies suitable process control equipment (e.g., a batch server, a industrial controller, individual devices, and so forth), process control steps, or methodologies to accomplish the manufacture of a particular item in accordance with the parameters of the specification. Identifier component 440 then associates a simulation model with one or more component or process steps. It should be appreciated that this may be performed by accessing database component 444, which stores the component and methodology simulation models.

If more than one component or process may be used to effectuate manufacture of a particular item, then the simulation component 402 employs logic component 450 to determine which component or process model to use. Logic component 450 can present business related information to the user to assist with the determination of the decision. For instance, logic component can present information to the user including cycle time for the product, costs associated with the process, level of automation of the process (e.g. how much babysitting operators will have to do), or amount of waste produced, and so forth.

When the identifier component 440 has identified the components or methodologies and defined simulation models for the respective components or steps, the simulation component 402 constructs, executes, and stores simulation results based upon the simulation models identified, as well as a cross-section of real-time variables (e.g., a range of operating temperatures, variations in materials such as thickness, properties, tolerance of materials, and so forth) that inherently occur in an industrial control setting. The real-time variables are stored in the database component 444, where the simulation component 402 generates and executes a separate simulation model for a given set of conditions. If a problem occurs during simulation or the simulation fails, the simulation component 402 identifies the particular simulation models that were the root of the failure. Generally, the simulation component simulates to the smallest level of granularity to facilitate the most accurate simulation possible.

The executed simulation models are then stored in database component 444 to provide a history of previously run simulation results. By storing the results of the simulations, users can quickly identify failed or successful simulations, as well as simulation models that are similar to the current simulation for comparative purposes.

To streamline future access, the database component 444 associates historical simulation results with simulation model components or process steps, associated components or process steps, and specification parameters that the simulation model may have been derived from. However, if a particular combination of simulation models has been run repeatedly, the simulation component 430 can identify this through the simulation database 410, notify the user that a repeated simulation has been executed, and refrain simulating that portion of the model after prompting the user for permission. This enables users to access a simulation history efficiently and circumvent costs or inefficient use of time associated with duplicate or even substantially similar simulations. Note that if multiple manufacturing paths exist, the simulation component 402 can simulate various paths and present the user with several options.

Alternatively, the simulation component 402 may prompt the user for a simulation model that is not found within the database, difficult to generate, or specific to the user. It should be appreciated that the user may provide such simulation model through a network such as the Internet. Simulation models may also be formed based on logic or artificial intelligence. In addition to logic component 450 or in place of the logic component described with reference to the system 400, the simulation component 402 can include an artificial intelligence (AI) component 460.

In accordance with this aspect, the AI component 460 automatically generates various simulation models. For example, if manufacture of an item incorporates processes A and B, and process A comprises steps C and D, while process B comprises steps E and F, AI component 460 can generate a simulation model that incorporates C, D, E, and F or combination thereof. The AI component 460 can include an inference component (not shown) that further enhances automated aspects of the AI components utilizing, in part, inference based schemes to facilitate inferring intended simulation models. The AI-based aspects of the invention can be effected via any suitable machine learning based technique or statistical-based techniques or probabilistic-based techniques or fuzzy logic techniques. Specifically, AI component 460 can implement simulation models based upon AI processes (e.g., confidence, inference). For example, a simulation model can be generated via an automatic classifier system and process which is described in further detail below.

A classifier is a function that maps an input attribute vector, x=(x1, x2, x3, x4, xn), to a confidence that the input belongs to a class, that is, f(x)=confidence(class). Such classification can employ a probabilistic or statistical-based analysis (e.g., factoring into the analysis utilities and costs) to prognose or infer an action that a user desires to be automatically performed. In the case of standing query creation and designation, for example, attributes can be file types or other data-specific attributes derived from the file types or contents, and the classes can be categories or areas of interest.

A support vector machine (SVM) is an example of a classifier that can be employed for AI. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, simulation tools can employ classifiers that are explicitly trained (e.g., via a generic training data) as well as implicitly trained (e.g., via observing user behavior, receiving extrinsic information). For example, SVM's can be configured via a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

Other implementations of AI could include alternative aspects whereby based upon a learned or predicted user intention, the system can generate hierarchical notifications or prompts. Likewise, an optional AI component could generate multiple prompts to a single or group of users based upon the received content.

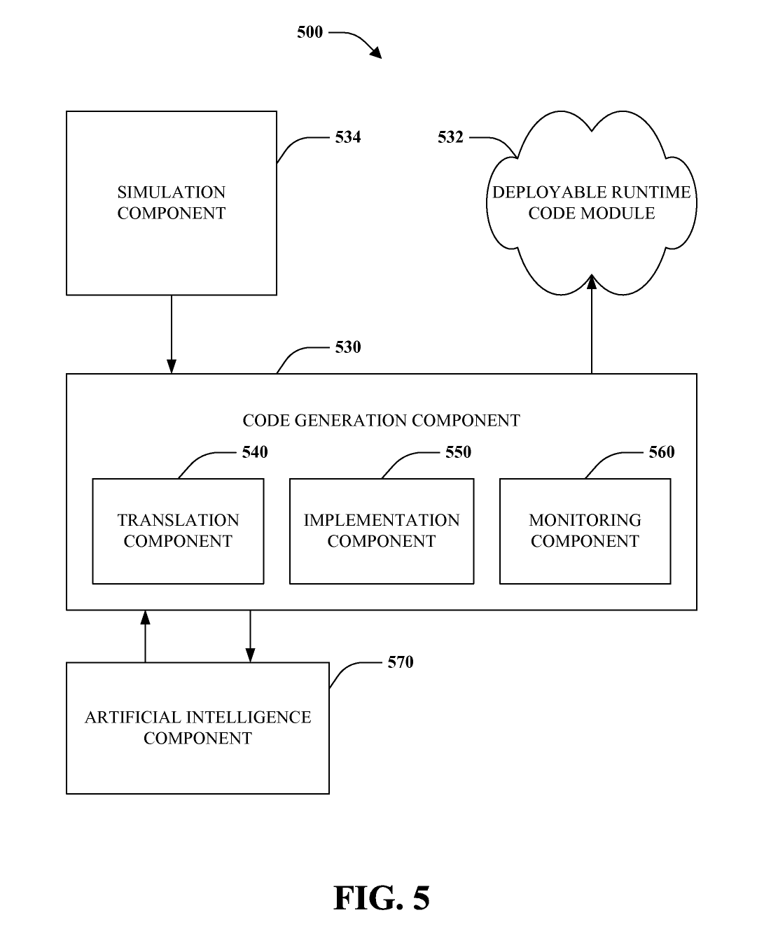

Turning now to FIG. 5, a system 500 illustrates a code generation component 530 that automatically creates deployable runtime code module 532. A simulation component 534 transmits results of a successful or partially successful simulation to the code generation component 530. Code generation component 530 includes a translation component 540 that obtains runtime code modules by mapping the simulation models into the appropriate controller or device specific language modules (described in more detail below). This may include ladder logic that drives industrial controllers, Sequential Function Charts, operational parameters or settings, programming language (e.g., C++, Java, or assembly) code to control various types of processors or other equipment. After optionally conferring with AI component 570, the code generation component 530 generates deployable runtime code module 532 that can be executed on an industrial controller, I/O module, communication module, intelligent module, robot, or other equipment.

In addition to the resultant deployable runtime code module 532, artificial intelligence component 570 facilitates generating additional runtime code modules that may not fall within user specifications. These additional code modules optimize aspects of that the user may not have taken into account when submitting their specification. For example, AI component 570 may factor cycle time, costs associated with manufacture, level of automation, amount of waste produced, historical user trends, anticipated user desires through interpolation or extrapolation, etc. into determining which aspect to optimize in the additional code module.

The code generation component 530 includes an implementation component 550 that links the code generation component to various controller components throughout a factory. One possible aspect involves linking deployable runtime code module 532 to the controller components via a network. An industrial control system can program the automatically generated runtime code modules in controllers linked to the code generation component 530. Alternatively, an operator may load the deployable runtime code modules 532 manually if the controller components are not remotely accessible.

A monitoring component 560 is also provided to track and log actual controller activity or responses and compare the actual results from implementation to the simulation models. This comparison provides a record of simulation accuracy and offers the user a continually updated database for improving correlation between simulation model results and real life occurrences.

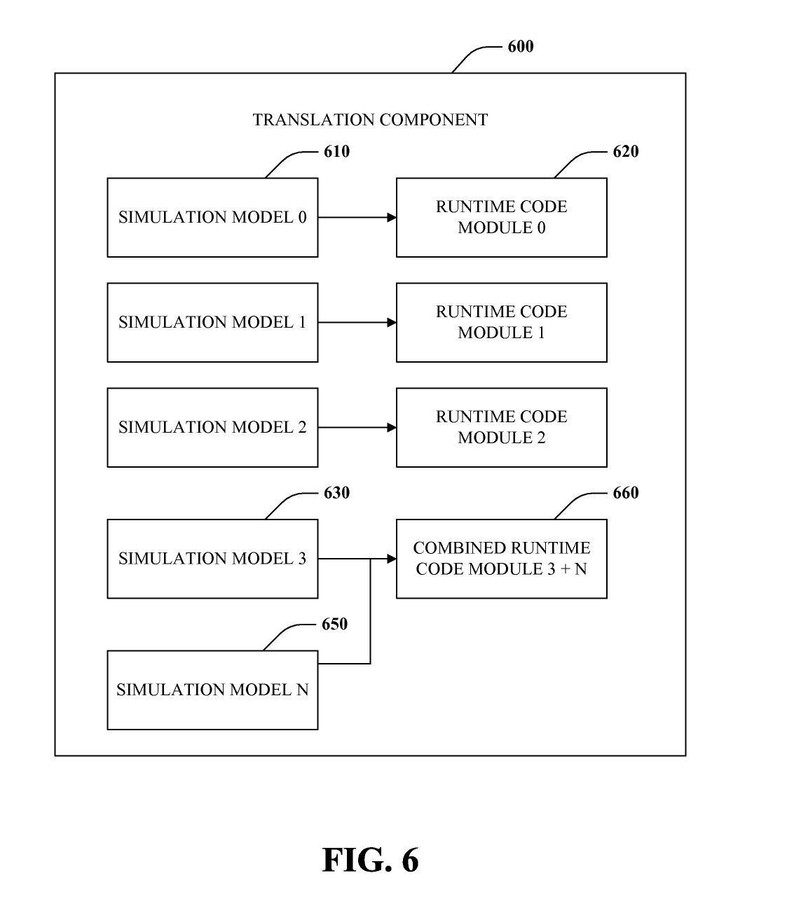

FIG. 6 illustrates a detailed example of how translation component 600 maps simulation models 610 to runtime code modules 620. As noted supra, runtime code modules 620 are generated, collected and stored for later reference. It should be noted that a simulation model 610 does not necessarily have a one to one corresponding relationship with a runtime code module 620, for example. In many cases, the translation component 600 receives simulation model 610 and maps the result to produce runtime code module 620. However, other instances may also apply, as a high-level simulation model could be mapped to produce two runtime code modules (situation not shown). Yet in another aspect, one simulation model 630 could be combined with another simulation model 650 to create combined runtime code module 660. A smaller subset of simulation models can create a larger set of runtime code modules. A subset of simulation models can also create a yet smaller subset of runtime code modules depending on the application. It can be advantageous to distribute simulated functionality across more or less code modules.

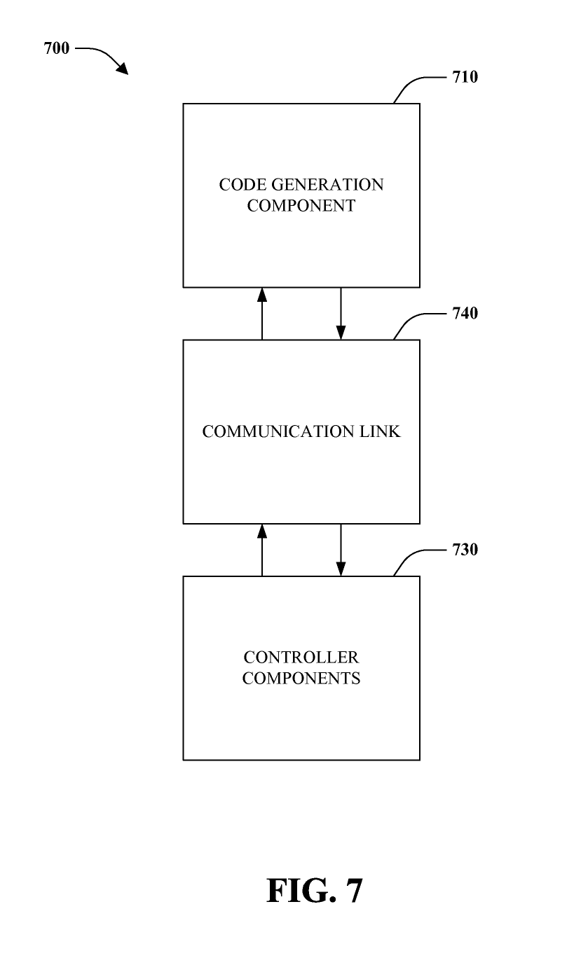

FIG. 7 illustrates communication of a deployable runtime code module 700 from a code generation component 710 to one or more controller components 730 via a communication link 740. Code generation component 710 generates a deployable runtime code module (not shown). The runtime code module substitutes for or enhances existing programs on the controller components 730. It is to be appreciated that the communication link 740 may include public networks such as the Internet, Ethernet, wireless networks, serial protocols, LANs, WANs, proxies, gateways, routers, firewalls, virtual private network (VPN) devices, servers, clients, computers, configuration tools, monitoring tools, or other devices.

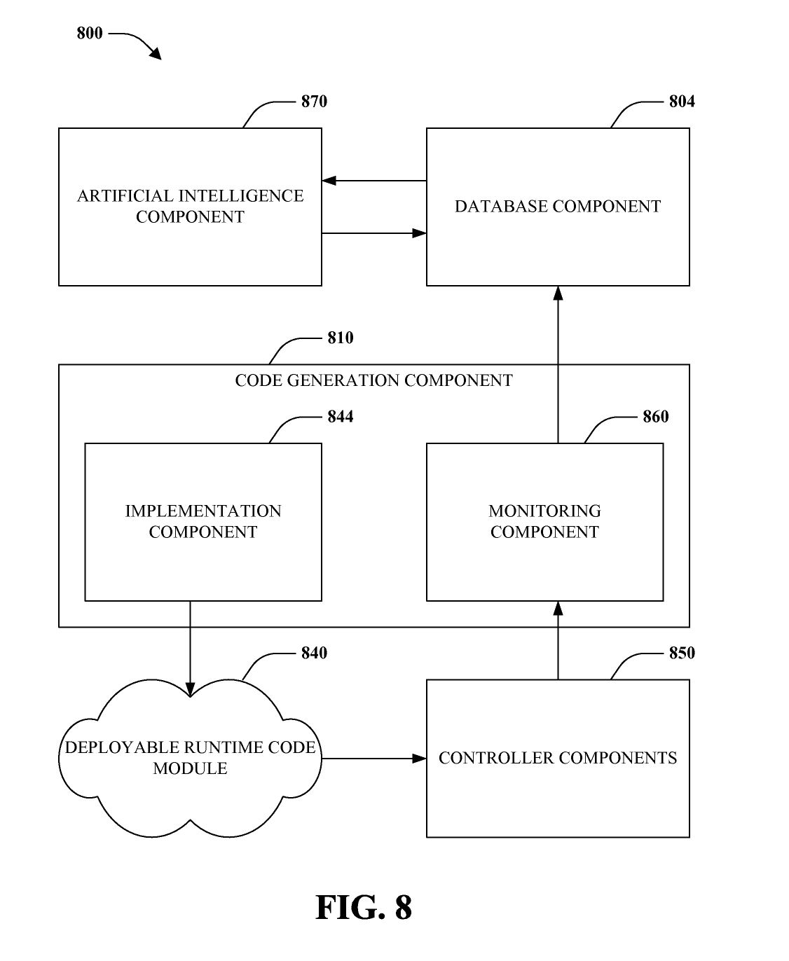

Turning now to FIG. 8, a system 800 illustrates a feedback loop to facilitate accuracy within simulations. First, a database component 804 stores back-ups of old versions of controller driver programs to ensure reliability. If the newly generated deployable runtime code does not execute to user satisfaction, database component 804 can restore the old controller driver program. It should be appreciated that database component 804 stores and associates many aspects of information relating to a deployable runtime code module: the runtime code module itself, the simulation result that mapped into one or more runtime code modules, the simulation models associated with the simulation result, the metadata relating to components or processes within the simulation model, the specification parameters that were originally provided or generated, as well as the cross-section of real-time variables to simulate across.

A code generation component 810 generates deployable runtime code module 840. An implementation component 844 then uploads the runtime code module 840 to controller components 850. Controller components 850 then provide feedback to monitoring component 860. The monitoring component 860 stores actual activity or responses from the controller to database 804 and associates the activity with the simulation results. Artificial intelligence (AI) component 870 can then calculate a comparison between the actual response and the simulation results. Upon determination of the comparison, the AI component 870 re-calculates a new version of the simulation model associated with the implementation of the deployable runtime code module 840 and compensates for the difference. For example if a controller drive controller is supposed to operate at one thousand RPMs and draw fifty milliamps of current, monitoring component might indicate that the RPM rate at which the motor is operating is nine hundred and ninety RPMS and that the motor is drawing fifty eight milliamps of current. In this situation, the AI component 870 will update simulation database 860 with a new simulation model (not shown) that accurately reflects the actual amount of current being drawn. Monitoring component 830 can also prompt the user to provide a new simulation model to account for discrepancies between the simulation model and the implemented runtime code module. Alternatively, the user can modify the simulation model with a compensation factor (e.g. real life variables such as friction, heat, and so forth).

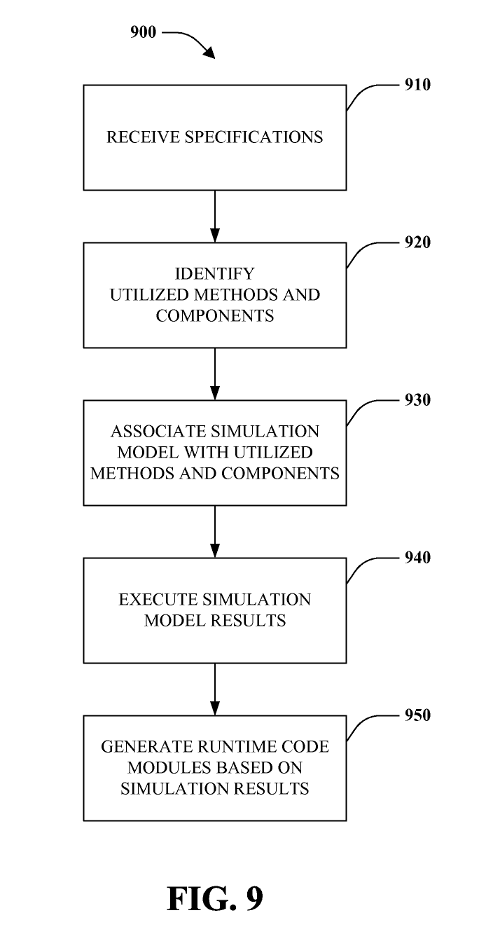

FIG. 9 illustrates a flow diagram 900 that demonstrates a methodology for automatic generation of a runtime code module. While, for purposes of simplicity of explanation, the methodology is shown and described as a series of acts, it is to be understood and appreciated that the methodologies are not limited by the order of acts, as some acts may occur in different orders or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

At 910, the process receives a set of specifications as an input to the process. The specifications can include user design preferences, performance specifications, or target operating objectives, for example. The specifications can be automatically generated or retrieved from a database or network, such as the Internet. Proceeding to 920, the process then identifies possible methods or components suitable to accomplish manufacture of a desired item. At 930, identified methods or components are associated with a corresponding simulation model. It should be appreciated that artificial intelligence can be used to generate a simulation model for a component or process step that does not have a corresponding simulation model. At 940, simulation models for the suitable processes and components are collected and a simulation is executed. At 950, a deployable runtime code module is generated based on the results of the simulation executed at step 940.

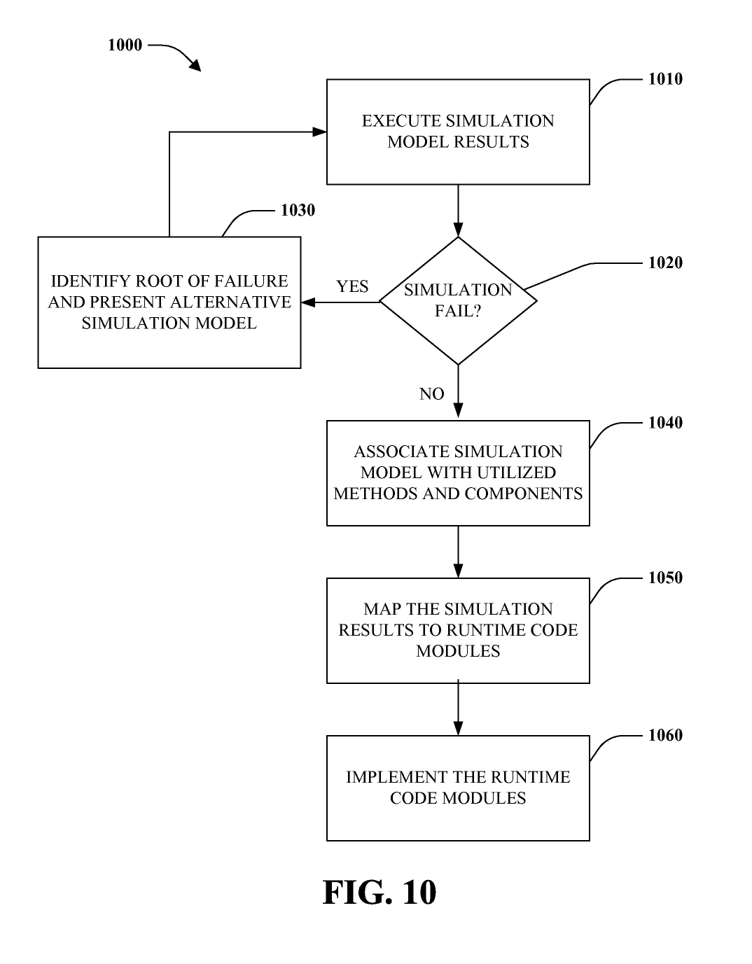

FIG. 10 illustrates a flow diagram 1000 that generates alternative simulation models taking the aspect of a failed simulation into account. At 1010, a simulation model is executed and the results are recorded. At decision node 1020, a determination is made as to whether the simulation failed. If the simulation fails, act 1030 identifies the root of the failure in the simulation and presents an alternative simulation model to execute again at 1010. If the simulation passes at decision node 1020, process 1000 moves on to 1040 to associate the simulation model with the components or process steps that were utilized in the model. At 1050, the simulation results are mapped to runtime code modules. At 1060, deployable runtime code modules are implemented into a controller program.

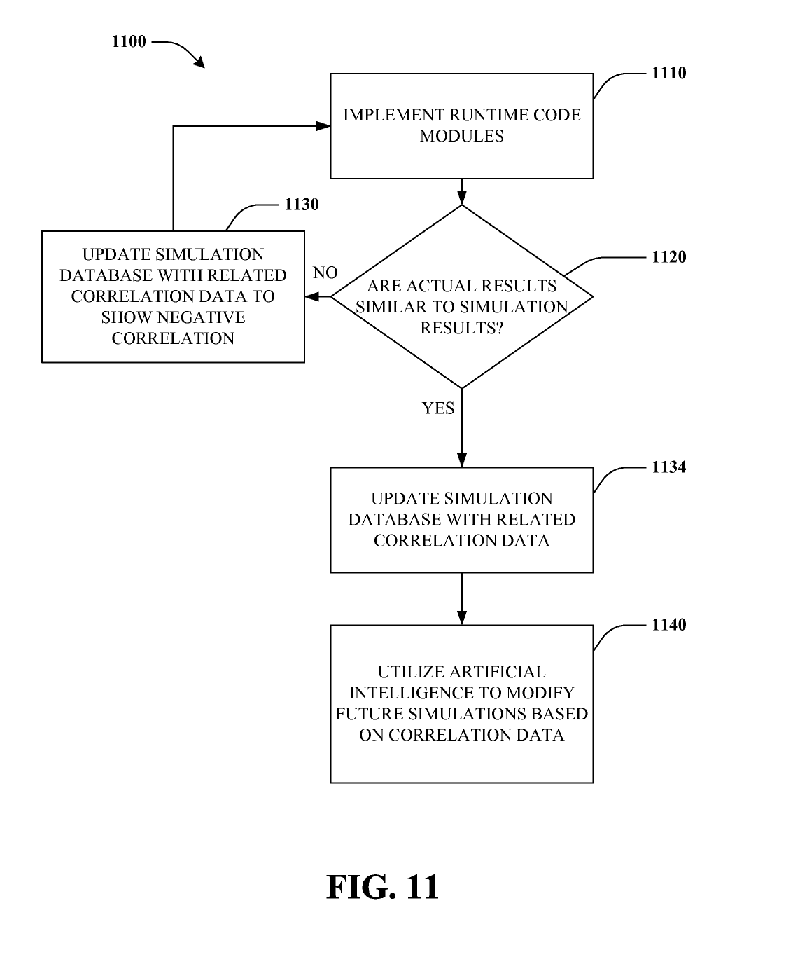

FIG. 11 illustrates a flow diagram 1100 that demonstrates a feedback methodology to improve simulation to code automation accuracy. At 1110, a deployable runtime code module is generated into a controller driver program. At 1120, actual results are compared to the results from the implementation at 1110. A determination is made to see if the results are substantially similar, and if not, then the process 1100 proceeds to 1130 to update the simulation database with the correlation data to compensate for any discrepancies between the simulation model and the actual response. A new runtime code module may optionally be generated (not shown) and implementation of the new version of the runtime code module could be repeated at 1110 until the actual results are similar enough to the simulation results to pass decision node 1120. If the simulation results are similar to the actual results, a record can be made to reflect the accuracy of the simulation at 1134. At 1140, artificial intelligence can be employed in future simulations to base the simulations off the correlation data updated in the simulation database.

The subject matter as described above includes various exemplary aspects of the subject invention. However, it should be appreciated that it is not possible to describe every conceivable component or methodology for purposes of describing these aspects. One of ordinary skill in the art may recognize that further combinations or permutations may be possible. Various methodologies or architectures may be employed to implement the subject invention, modifications, variations, or equivalents thereof. Accordingly, all such implementations of the aspects described herein are intended to embrace the scope and spirit of subject claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A simulation code generation tool for an automation system, comprising:
a simulation component that creates and executes a simulation model of one or more components of an industrial control system; and
a code generator component that automatically builds executable runtime code for the one or more components of the industrial control system.

2. The system of claim 1, the execution components are generated as re-usable models for the simulation component.

3. The system of claim 1, the execution components are generated as run-time modules for the one or more components of the industrial control system.

4. The system of claim 1, further comprising an artificial intelligence component that creates simulation models for a failed simulation or a new configuration of components in the industrial control system.

5. The system of claim 1, the code generator component further comprises a translation component that maps one or more simulation models to one or more blocks of executable runtime code.

6. The system of claim 1, the code generator component further comprises an implementation component that downloads the executable runtime code to an industrial controller and a monitoring component that compares actual controller responses to a corresponding simulation module.

7. The system of claim 6, further comprising a database component that stores correlation data from the monitoring component and updated simulation models for an industrial control system.

8. The system of claim 7, further comprising an input component that accepts a set of specifications from a user, the specifications include design preferences, performance goals, or objectives.

9. The system of claim 8, further comprising an identifier component that determines components or methodologies suitable to achieve specifications set forth by a user and correlates a simulation model to suitable components or methodologies.

10. The system of claim 8, further comprising a logic component that determines whether the specifications are within manufacturing capabilities.

11. A method of generating simulation code for an automation system, comprising:
executing a simulation of an industrial automation system; and
generating executable code based at least in part on results of the simulation.

12. The method of claim 11, further comprising:
receiving a set of specifications;
identifying components or methods suitable to meet the specifications; and
associating the simulation of the industrial automation system with one or more simulation models of the identified components or methods.

13. The method of claim 11, further comprising:
identifying at least one simulation model that failed simulation;
creating an alternative simulation model; and
re-executing the simulation.

14. The method of claim 11, further comprising monitoring simulations to determine alternative executable code modules.

15. The method of claim 14, further comprising learning the alternative executable code modules via one or more classifier processes.

16. The method of claim 11, further comprising generating one or more parameters and associating the one or more parameters with one or more fields of a specification.

17. The method of claim 11, further comprising generating at least one simulation model for a component of an industrial automation system, the component includes a programmable controller, an input/output module, a communication module, and an intelligent module.

18. The method of claim 17, further comprising translating the simulation model into one or more runtime code modules.

19. The method of claim 18, the runtime code modules are associated with ladder logic, Sequential Function Logic, input/output module codes, communication codes, or remote Internet interface code.

20. A system to automatically generate executable control code, comprising:
means for defining one or more specifications of a control system;
means for simulating the specifications; and
means for generating run time code from simulation of the specifications.
